(19) United States
(12) Patent Application Publication
(10) Pub. No.: US 2009/0190922 A1
(43) Pub. Date: Jul. 30, 2009

(54) Communication system

(75) Inventors: Yasunori Ohta, Ashigarakami-gun (JP); Naoyuki Nishino, Ashigarakami-gun (JP); Eiichi Kito, Ashigarakami-gun (JP)

Correspondence Address: Moss & Burke, PLLC, 401 Holland Lane, Suite 407, Alexandria, VA, 22314, US

(73) Assignee: FUJIFILM CORPORATION, Tokyo (JP)

(21) Appl. No.: 12/320,510

(22) Filed: Jan. 28, 2009

(30) Foreign Application Priority Data
Jan. 30, 2008 (JP) 2008-019760
Jan. 30, 2008 (JP) 2008-019761

(51) Int. Cl. H04B 10/08; H04B 10/12

(52) U.S. Cl. 398/17; 398/141

(57) ABSTRACT

A communication system includes a first device and a second device. The first device includes a first housing including a first guiding member, a modulator modulating a laser beam based on transmission information, and an emission unit emitting the laser beam that has been modulated. The second device includes a second housing including a light-receiving region on an outer surface of the second housing, a receiver that, when a relative position between the first and the second housings is adjusted to a communicable position at which the modulated laser beam is incident within the light-receiving region, receives the transmission information from the first device by detecting the modulated laser beam and demodulating the transmission information based on the detection result, and a second guiding member being disposed on the second housing and guides the first and the second housings to the communicable position by contacting the first guiding member.

### CROSS-REFERENCE TO RELATED APPLICATION

This application claims priority under 35 USC 119 from Japanese Patent Applications No. 2008-019760 and No. 2008-019761, the disclosures of which are incorporated by reference herein.

### BACKGROUND OF THE INVENTION

1. Field of the Invention The present invention relates to a communication system, and more particularly, to a communication system transmitting and receiving data between electronic devices by the use of a laser beam that has been modulated in accordance with transmission information.

2. Description of the Related Art

In recent years, a technique of making a radio communication at a very high transfer rate (for example, 1 Gb/s) using a laser beam in an infrared wavelength range was suggested (see “The Realization of Infrared Wireless Communication at a Transmission Speed of 1 Gbit/s Using a Mobile Telephone,” KDDI R&D Laboratories, INC., http://www.kddilabs.jp/press/img/83_{—}1.pdf). By employing this technique, in transmitting and receiving data between electronic devices, it is possible to completely transmit and receive a large amount of data for a short time without connecting the electronic devices transmitting and receiving data each other through a communication cable or the like even when at least one electronic device has portability and transmits and receives a large amount of data. Accordingly, this technique can be used in various applications such as greatly reducing the communication time for a radio communication between devices or transmitting and receiving a large amount of data between devices, which have not been assumed for use in the radio communication.

For example, Japanese Patent No. 3494683 discloses a radiation detector cassette (also referred to as electronic cassette) having a configuration in which a radiation detector and an image memory are built therein, a radiographic image detected by the radiation detector is stored as image data in the image memory, and the image data read from the image memory is converted into radio signals and is output to an external signal processing circuit. Since plural devices not suitable for an environment where electric waves are radiated exist in medical sites, the radio communication suitable for the cassette was limited to an infrared communication based on an infrared data association (IrDA) standard in the past. However, since the communication speed is about 115 kb/s to 6 Mb/s in the infrared communication based on the IrDA standard but the reversible compression having a low compression rate is selected for compressing image data to prevent the bad influence on reading images in such a type of medical devices, a very long time is required for transmitting the image data. On the contrary, when the above-mentioned communication using a laser beam is employed as the radio communication in the cassette, it is possible to greatly reduce the transfer time for the image data.

Japanese Patent Application Laid-Open (JP-A) No. 2007-81134 discloses an optical communication module having a laser diode disposed in a lead frame and a transparent resin section as an adjuster for carrying out optical output distribution extension and output adjustment of the laser diode, where the transparent resin section includes a transparent resin sealing the laser diode and a glass filler which is added to the transparent resin to be substantially uniformly distributed in the entire transparent resin and which exhibits a light transmitting and diffusing function.

When electronic devices make a radio communication with each other using a laser beam and at least one electronic device has portability, the radio communication is made when both electronic devices are arranged in a positional relation where both can make the radio communication using a laser beam. However, since at least one electronic device has the portability, it is very troublesome to arrange both electronic devices in the positional relation where both can make the radio communication using a laser beam. In addition, when a deviation occurs in the positional relation between both electronic devices, the deviation in positional relation may cause leakage of the laser beam from a space between both electronic devices.

On the contrary, in the technique described in JP-A No. 2007-81134, the extension of a light output distribution of the optical communication module and the deterioration in light output intensity of the optical communication module are embodied by repeating the refraction of light from the laser diode by the use of the glass filler. Here, the adjustment of the positional relation between the electronic devices making a communication using a laser beam is not considered at all. The leakage of the laser beam is not considered at all when the relative position between the electronic devices in communication using the laser beam varies.

### SUMMARY OF THE INVENTION

The present invention has been made in view of the above circumstances and provides a communication system.

A first aspect of the present invention provides a communication system including a first device and a second device. The first device includes a first housing that includes a first guiding member, a modulator that modulates a laser beam in accordance with transmission information, and an emission unit that emits the laser beam that has been modulated at the modulator. The second device includes a second housing that includes a light-receiving region on an outer surface of the second housing, a receiver, and a second guiding member that is disposed on the second housing and guides the first and the second housings to the communicable position by contacting the first guiding member. The receiver receives the transmission information from the first device by detecting the modulated laser beam and demodulating the transmission information based on the detection result, when a relative position between the first and the second housings is adjusted to a communicable position at which the modulated laser beam is incident within the light-receiving region.

A second aspect of the present invention provides a communication system including a first device and a second device. The first device includes a first housing that includes a first guiding member, a modulator that modulates a laser beam in accordance with transmission information, and an emission unit that emits the laser beam that has been modulated at the modulator. The second device includes a second housing that includes a light-receiving region on an outer surface of the second housing, a receiver, a holder that is disposed on the second housing and prevents relative displacement between the first housing and the second housing by holding the first housing when the relative position between the first and the second housings is adjusted to the communicable position. The receiver receives the transmission information from the first device by detecting the modulated laser beam and demodulating the transmission information based on the detection result, when a relative position between the first and the second housings is adjusted to a communicable position at which the modulated laser beam is incident within the light-receiving region.

### BRIEF DESCRIPTION OF THE DRAWINGS

FIG. 1 is a block diagram schematically illustrating configurations of an electronic cassette and an image reader according to a first embodiment of the invention.

FIG. 2A is a diagram schematically illustrating an arrangement of the electronic cassette at the time of taking a radiographic image and FIG. 2B is a perspective view illustrating an internal structure of the electronic cassette.

FIG. 3 is a perspective view illustrating appearances of the electronic cassette and the image reader according to the first embodiment of the invention.

FIGS. 4A and 4B are side views illustrating a positioning operation of a protrusion and a positioning hole.

FIGS. 5A and 5B are side views illustrating an electronic cassette holding operation using a connector coupling.

FIG. 6 is a perspective view illustrating appearances of an electronic cassette and an image reader according to a second embodiment of the invention.

FIGS. 7A and 7B are side views illustrating an engagement of a groove disposed in a side surface of a casing of the electronic cassette and a protrusion disposed in a casing of the image reader.

FIGS. 8A to 8C are side views illustrating an engagement of a groove disposed in a side surface of the casing of the electronic cassette and a holding member disposed in the casing of the image reader.

FIG. 9 is a perspective view illustrating appearances of an electronic cassette and an image reader according to a third embodiment of the invention.

FIG. 10 is a perspective view illustrating appearances of an electronic cassette and an image reader according to a fourth embodiment of the invention.

### DETAILED DESCRIPTION OF THE INVENTION

Hereinafter, embodiments of the invention are described in detail with reference to the drawings.

### First Embodiment

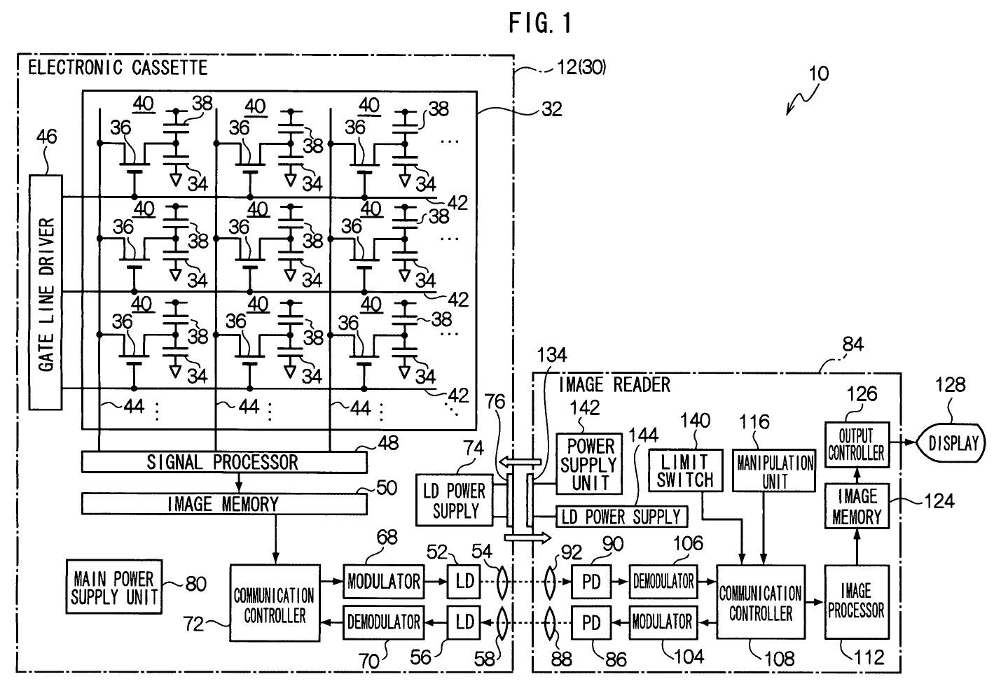

FIG. 1 illustrates a radiographic image treating system 10 according to a first embodiment. The radiographic image treating system 10 includes an electronic cassette 12 having portability and being capable of converting image information into image data and storing the image data every time a radiation carrying the image information is radiated and an image reader 84 capable of reading the image data stored in the electronic cassette 12. The electronic cassette 12 corresponds to a portable radiographic image converter and the image reader 84 corresponds to an image reader.

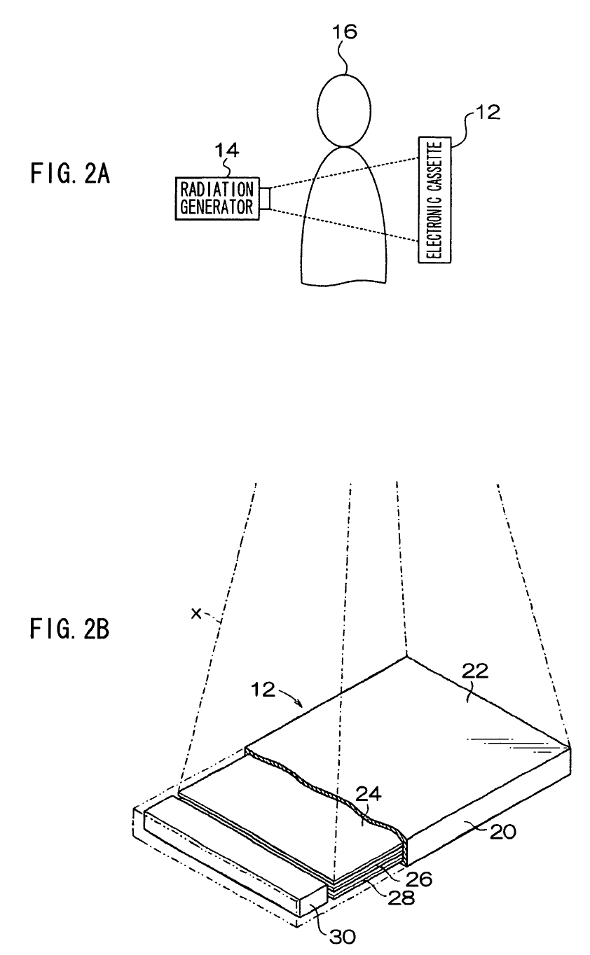

As shown in FIG. 2A, the electronic cassette 12 is disposed with a gap from a radiation generator 14 generating a radiation such as X-rays at the time of taking a radiographic image. A photographing position for a subject 16 is set between the radiation generator 14 and the electronic cassette 12. When it is instructed to take a radiographic image, the radiation generator 14 emits a radiation with a radiation intensity corresponding to a predetermined photographing condition. The radiation emitted from the radiation generator 14 is transmitted by the subject 16 located at the photographing position to carry image information and then is applied to the electronic cassette 12.

As shown in FIG. 2B, the electronic cassette 12 is formed of a material transmitting a radiation X and is covered with a panel-like casing (housing) 20 having a thickness. In the casing 20, a grid 24 removing a scattered radiation of the radiation X resulting from passing through the subject 16, a radiation detector (radiation detecting panel) 26 detecting the radiation X, and a lead plate 28 absorbing a back scattered radiation of the radiation X are sequentially arranged from an irradiated surface 22 of the casing 20 irradiated by the radiation X. The irradiated surface 22 of the casing 20 may be formed of the grid 24. A case 30 for receiving various circuits (to be described later) including a micro computer is disposed at one end in the casing 20. To prevent various circuits received in the case 30 from being damaged by the application of the radiation X, a lead plate or the like may be disposed on the side of the case 30 close to the irradiated surface 22.

In the radiation detector 26 of the electronic cassette 12, a photoelectric conversion layer absorbing a radiation and converting the absorbed radiation into electric charges is stacked on a TFT active matrix substrate 32 shown in FIG. 1. The photoelectric conversion layer is formed of amorphous selenium (a-Se) containing selenium as a major component (for example, a content of 50% or more) and converts the applied radiation into electric charges by generating electric charges (pairs of electron and hole) of a charge amount corresponding to the intensity of the applied radiation. Plural pixel units 40 (the photoelectric conversion layers corresponding to the pixel units 40 are shown as a photoelectric converter 38 in FIG. 1) each having a storage capacitor 34 accumulating the electric charges generated in the photoelectric conversion layer and a TFT 36 for reading the electric charges accumulated in the storage capacitor 34 are arranged in a matrix on the TFT active matrix substrate 32. The electric charges generated in the photoelectric conversion layer with the application of the radiation to the electronic cassette 12 are accumulated in the storage capacitor 34 of the respective pixel units 40. Accordingly, the image information carried by the radiation applied to the electronic cassette 12 is converted into the charge information and is held by the radiation detector 26.

The TFT active matrix substrate 32 is provided with plural gate lines 42 extending in a predetermined direction (row direction) to turn on and off the TFT 36 of the respective pixel units 40 and plural data lines 44 extending in a direction (column direction) perpendicular to the gate lines 42 to read the accumulated electric charges from the storage capacitor 34 through the turned-on TFT 36. The respective gate lines 42 are connected to a gate line driver 46 and the respective data lines 44 are connected to a signal processor 48. When the electric charges are accumulated in the storage capacitor 34 of the respective pixel units 40, the TFT 36 of the respective pixel units 40 is turned on in the order of rows by a signal supplied from the gate line driver 46 through the gate lines 42 and the electric charges accumulated in the storage capacitors 34 of the pixel units 40 of which the TFT 36 is turned on are transmitted as electric signals to the data lines 44 and are input to the signal processor 48. Accordingly, the electric charges accumulated in the storage capacitor 34 of the respective pixel units 40 are read in the order of rows.

Although not shown, the signal processor 48 has an amplifier and a sampling and holding circuit disposed for the respective data lines 44 and the charge signals transmitted to the respective data lines 44 are amplified by the amplifier and then are held in the sampling and holding circuit. A multiplexer and an A/D converter are sequentially connected to the output side of the sampling and holding circuit. The electric charge signals held in the respective sampling and holding circuits are sequentially (serially) input to the multiplexer and are converted into digital image data by the A/D converters. An image memory 50 is connected to the signal processor 48 and the image data output from the A/D converter of the signal processor 48 are sequentially stored in the image memory 50. The image memory 50 has a memory capacity capable of storing image data corresponding to plural frames and image data taken by photographing are sequentially stored in the image memory 50 every time taking a radiographic image.

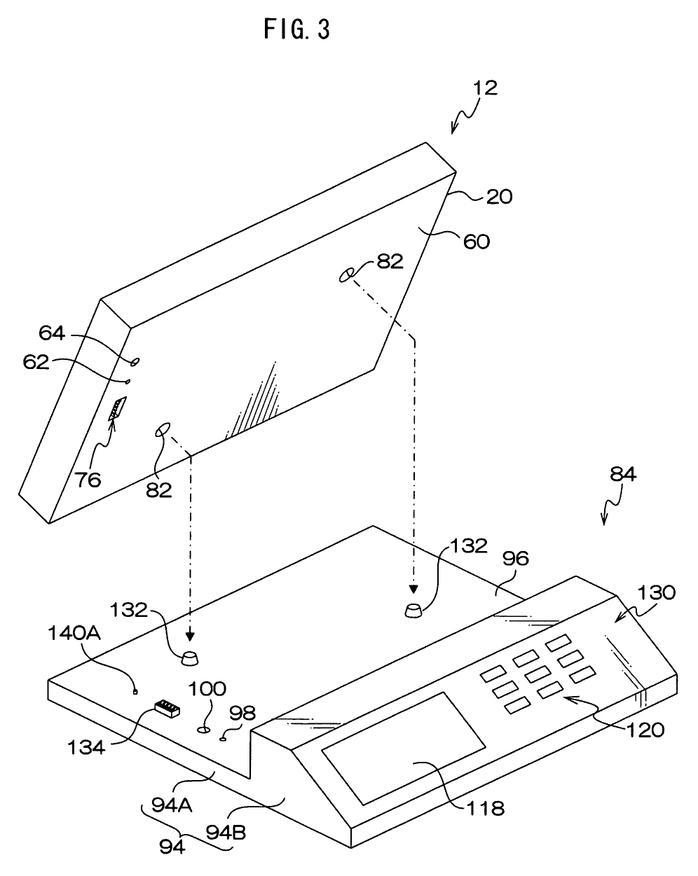

The electronic cassette 12 has a function of making a radio communication using a laser beam with the image reader 84 and includes a laser diode (LD) 52 as a laser beam source and a photo diode (PD) 56 detecting a laser beam input from the outside. To enhance the communication speed between the electronic cassette 12 and the image reader 84, it is preferable that the LD 52 is an LD emitting a laser beam having a wavelength in an infrared region and the PD 56 is a PD having sensitivity to the wavelength in the infrared region. In the first embodiment, as shown in FIG. 3, a bottom surface 60, opposite to the irradiated surface 22, of the casing 20 of the electronic cassette 12 is provided with an emission hole 62 transmitting the laser beam emitted from the LD 52 and a light-receiving hole 64 transmitting the laser beam from the outside (for example, the image reader 84).

In this embodiment, when information is transmitted and received between the electronic cassette 12 and the image reader 84 using a laser beam, the casings of the electronic cassette 12 and the image reader 84 are disposed so that the surface (the bottom surface 60 in the first embodiment), having the emission hole 62 and the light-receiving hole 64, of surfaces of the casing 20 of the electronic cassette 12 is opposed to a surface (to be described later), having an emission hole and a light-receiving hole, of the surfaces of a casing of the image reader 84. Accordingly, in the following description, the surfaces, having the emission hole and the light-receiving hole, of the surfaces of the casing 20 of the electronic cassette 12 and the surfaces of the casing of the image reader 84 are referred to as “opposed surfaces”, respectively. The laser beam emitted from the LD 52 is transmitted by a lens 54 (see FIG. 1) disposed on a laser beam emission side of the LD 52 and is emitted externally from the casing 20 through the emission hole 62. The laser beam from the outside is transmitted by the light-receiving hole 64, is transmitted by a lens 58 (see FIG. 1) disposed on a light incidence side of the PD 56, and is received by the PD 56.

The LD 52 is connected to a communication controller 72 through a modulator 68. The communication controller 72 is embodied by a micro computer and serves to output transmission information to the modulator 68 at the time of transmitting information to the image reader 84 and to instruct the intensity of the laser beam emitted from the LD 52 to the modulator 68. The modulator 68 modulates the laser beam emitted from the LD 52 in a predetermined modulation manner in accordance with the input transmission information and controls the driving of the LD 52 so that the intensity of the laser beam emitted from the LD 52 agrees to the instructed intensity. Accordingly, the laser beam that has been modulated in accordance with the transmission information is emitted from the LD 52 with the intensity instructed by the communication controller 72.

The PD 56 is connected to the communication controller 72 through a demodulator 70. When the external laser beam is received by the PD 56 and the received intensity signal corresponding to the received intensity of the laser beam is input from the PD 56, the demodulator 70 demodulates the information (information transmitted from an opposite communication device) carried by the received laser beam in a predetermined demodulation manner on the basis of the input received intensity signal and outputs the demodulated information to the communication controller 72.

The electronic cassette 12 is provided with a main power supply unit 80. The main power supply unit 80 supplies power to various circuits or elements (such as the gate line driver 46, the signal processor 48, the image memory 50, the micro computer serving as the communication controller 72 or a position change monitoring unit 78, the modulator 68, the LD 52, the PD 56, and the demodulator 70) other than the LD 52. The various circuits or elements other than the LD 52 operate with the power supplied from the main power supply unit 80. A configuration having a battery (rechargeable secondary battery) built therein and supplying power to the various circuits or elements from the charged battery is suitable for the main power supply unit 80 so as not to damage the portability of the electronic cassette 12. However, the battery may employ a primary battery or may have a configuration in which it is normally connected to a commercial power source to rectify and transform the power supplied from the commercial power source and to supply the power to various circuits or elements.

The electronic cassette 12 is provided with an LD power supply 74. The LD power supply 74 is connected to a connector 76 (to be described later), operates with the power supplied from the image reader 84 through the connector 76, supplies the power supplied from the image reader 84 through the connector 76 to the LD 52, and supplies some of the power supplied from the image reader 84 to (an LD power supply 144 to be described later of the image reader 84 through the connector 76. The LD 52 of the electronic cassette 12 operates with the power supplied from the LD power supply 74.

As shown in FIG. 3, the casing 94 of the image reader 84 according to the first embodiment is provided with a panel-like mounting section 94A mounted with the electronic cassette 12 and a main body section 94B having a thickness slightly greater than that of the mounting section 94A, receiving various circuits, and having a manipulation panel 130 attached thereto are disposed aside the mounting section 94A. The image reader 84 has a function of making a radio communication using a laser beam with the electronic cassette 12 and includes an LD 86 as a laser beam source and a PD 90 detecting the laser beam input externally, as shown in FIG. 1. To enhance the communication speed between the electronic cassette 12 and the image reader 84, similarly to the electronic cassette 12, it is preferable that the LD 86 is an LD emitting a laser beam having a wavelength in an infrared region and the PD 90 is a PD having sensitivity to the wavelength in the infrared region.

In the first embodiment, when information is transmitted and received between the electronic cassette 12 and the image reader 84 using a laser beam, the electronic cassette 12 is mounted on the mounting section 94A so that the opposed surface 60 thereof is opposed to the top surface of the mounting section 94A in the casing 94 of the image reader 84. As shown in FIG. 3, the top surface of the mounting section 94A of the image reader 84 is provided with an emission hole 98 transmitting the laser beam emitted from the LD 86 and a light-receiving hole 100 transmitting the laser beam from the outside (for example, the electronic cassette 12) (hereinafter, the top surface of the mounting section 94A is referred to as “opposed surface 96”). The laser beam emitted from the LD 86 is transmitted by a lens 88 (see FIG. 1) disposed on a laser beam emission side of the LD 86 and is emitted externally from the casing 94 through the emission hole 98. The externally input laser beam is transmitted by the light-receiving hole 100, is transmitted by a lens 92 (see FIG. 1) disposed on a light incidence side of the PD 90, and is received by the PD 90.

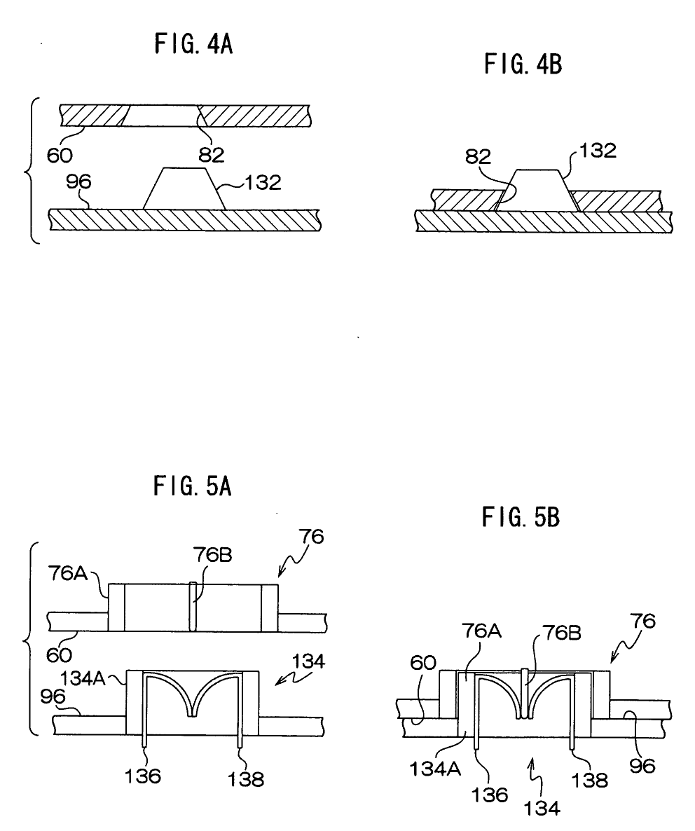

When the electronic cassette 12 is correctly located at a predetermined position (communicable position) on the opposed surface 96, the emission hole 98 and the light-receiving hole 100 disposed in the opposed surface 96 are disposed so that the light-receiving hole 100 is opposed to the emission hole 62 and the emission hole 98 is opposed to the light-receiving hole 64. As shown in FIG. 3, protrusions 132 are disposed at plural positions on the opposed surface 96. As shown in FIGS. 4A and 4B, each protrusion 132 has a shape (substantially a mountain shape) obtained by removing the vertex of a cone and the side surface thereof is tapered. On the other hand, positioning holes 82 are formed at plural positions, which correspond to the protrusions 132 when the electronic cassette 12 is correctly disposed at the communicable position on the opposed surface 96, on the opposed surface 60 of the casing 20 of the electronic cassette 12. As shown in FIGS. 4A and 4B, the side wall surfaces of the positioning holes 82 are tapered along the side surfaces of the protrusions 132.

The opposed surface 96 of the image reader 84 is provided with a connector 134. As shown in FIG. 5A, terminals 136 and 138 are disposed in a case 134A of the connector 134. The ends of the terminals 136 and 138 are curved in an arc shape and are received in the case 134A when the curved portions are opposed to each other and the ends are in contact with each other. Plural pairs of terminals 136 and 138 are disposed in the case 134A of the connector 134 and the respective pairs of terminals are electrically insulated from each other. A hole is formed at a position, which corresponds to the connector 134 when the electronic cassette 12 is positioned at the communicable position on the opposed surface 96, on the opposed surface 60 of the casing 20 of the electronic cassette 12 and a connector 76 is received in the hole. As shown in FIG. 5A, the case 76A of the connector 76 is set so that the inner size of the case 76A is slightly greater than the outer size of the case 134A to receive the case 134A of the connector 134, and the same number of flat terminals 76B as the pairs of terminals 136 and 138 disposed in the case 134A of the connector 134 are arranged in the case 76A of the connector 76.

The LD 86 is connected to a communication controller 108 through a modulator 104. The communication controller 108 is embodied by a micro computer and serves to output transmission information to the modulator 104 at the time of transmitting information to the electronic cassette 12 and to instruct the intensity of the laser beam emitted from the LD 86 to the modulator 104. The modulator 104 modulates the laser beam emitted from the LD 86 in a predetermined modulation manner on the basis of the input transmission information and controls the driving of the LD 86 so that the intensity of the laser beam emitted from the LD 86 agrees to the instructed intensity. Accordingly, the laser beam that has been modulated in accordance with the transmission information is emitted from the LD 86 with the intensity instructed by the communication controller 108.

The PD 90 is connected to the communication controller 108 through a demodulator 106. When the external laser beam is received by the PD 90 and the received intensity signal corresponding to the received intensity of the laser beam is input from the PD 90, the demodulator 106 demodulates the information (information transmitted from an opposite communication device) carried by the received laser beam in a predetermined demodulation manner on the basis of the input received intensity signal and outputs the demodulated information to the communication controller 108.

A manipulation unit 116 is connected to the communication controller 108. As shown in FIG. 3, the manipulation unit 116 includes a display 118 disposed on the manipulation panel 130 of the main body section 94B of the casing 94 to display information including various messages and a keyboard 120 disposed similarly in the casing 94 and having plural keys. Various instructions or information input by allowing a user to manipulate the keyboards 120 is input to the communication controller 108 and the display of information on the display 118 is controlled by the communication controller 108.

A limit switch 140 is connected to the communication controller 108. In the limit switch 140, a contactor thereof has a pin shape and the end of the contactor is disposed to protrude from the opposed surface 96 as shown in FIG. 3 (the contactor of the limit switch 140 is referenced by reference numeral “140A” in FIG. 3). The limit switch 140 is disposed so that the end of the contactor 140A is pressed by the opposed surface 60 and a contact point is changed when the casing 20 of the electronic cassette 12 is mounted on the opposed surface 96 of the image reader 84 and the opposed surface 60 comes in contact with the opposed surface 96.

An image memory 124 is connected to the communication controller 108 through an image processor 122. In the communication between the electronic cassette 12 and the image reader 84, as described later, the image data stored in the image memory 50 of the electronic cassette 12 is transmitted to the image reader 84, and the image processor 122 performs various image processes (for example, a process of removing noises from the image data or a process of correcting an image deviation of the image data due to the deviation in characteristic of the pixel units 40 of the radiation detector 26) on the image data received from the electronic cassette 12 and sequentially output from the communication controller 108 and stores the image data having been subjected to various image processes in the image memory 124.

An output controller 126 is connected to the image memory 124. The output controller 126 controls the reading of the image data from the image memory 124 and the output of the image data to an external device at the time of outputting the image data stored in the image memory 124 to the external device. A display 128 is shown as a typical example of the external device in FIG. 1. When the external device is the display 128, the image (radiographic image) indicated by the image data stored in the image memory 124 is displayed on the display 128 by the output controller 126. An example of the external device can include, in addition to the display 128, a printer printing the image indicated by the image data on a sheet-like printing medium, an information recording device recording the image data on a CD-R or a known other information recording medium, and a communication device transmitting the image data to an information processing device connected thereto through a communication network.

A power supply unit 142 is disposed in the image reader 84. The power supply unit 142 is normally connected to a commercial power source and serves to rectify and transform the power supplied from the commercial power source and to supply the power to various circuits or elements (the demodulator 106, the modulator 104, the PD 86, the communication controller 108, the manipulation unit 116, the image processor 112, the image memory 124, and the output controller 126) other than the LD 90 in the image reader 84. The circuits or elements other than the LD 90 in the image reader 84 and the circuits or elements other than the LD 52 operate with the power supplied from the main power supply unit 80. The power supply unit 142 is also connected to the connector 134 and also supplies the power to the LD power supply 74 of the electronic cassette 12 when the connector 76 is connected to the connector 134.

An LD power supply 144 is disposed in the image reader 84. The LD power supply 144 is connected to the connector 134 and operates to supply the power supplied through the connectors 76 and 134 from the electronic cassette 12 to the LD 52 when the connector 76 is connected to the connector 134 and the power is supplied from the LD power supply 74 of the electronic cassette 12 through the connectors 76 and 134. The LD 90 of the image reader 84 operates with the power supplied from the LD power supply 144.

The communication between the electronic cassette 12 and the image reader 84 is described below. When a user intends to display the image data, which is stored in the image memory 50 of the electronic cassette 12 by taking a radiographic image, as an image on the display 128, the user first grasps the casing 20 of the electronic cassette 12 storing the image data to be read so that the opposed surface 60 is directed downward and then moves the casing to a space above the mounting section 94A of the image reader 84. Then, the user adjusts the horizontal position of the casing 20 of the electronic cassette 12 so that the casing 20 of the electronic cassette 12 is located substantially above the communicable position when the opposed surface 60 of the casing 20 of the electronic cassette 12 is opposed to the opposed surface 96 of the casing 94 of the image reader 84, and then moves down the casing 20 up to the position at which the opposed surface 60 comes in contact with the opposed surface 96.

Here, even when the horizontal position of the casing 20 is slightly deviated from the communicable position at the time of moving the casing 20 downward and thus the axis lines of the protrusions 132 disposed on the opposed surface 96 are slightly deviated from the centers of the corresponding positioning holes 82 disposed in the opposed surface 60 as shown in FIG. 4A, the ends of the protrusions 132 are inserted into the corresponding positioning holes 82 and the tapered side surfaces of the protrusions 132 come in contact with the tapered side wall surfaces of the corresponding positioning holes 82. Accordingly, as shown in FIG. 4B, since the horizontal position of the casing 20 of the electronic cassette 12 is guided (moved) with the downward movement of the casing 20 so that the axis lines of the protrusions 132 agree to the centers of the corresponding positioning holes 82, the casing 20 of the electronic cassette 12 is accurately positioned at the communicable position on the opposed surface 96 of the image reader 84. Accordingly, the emission hole 62 in the opposed surface 60 is accurately opposed to the light-receiving hole 100 in the opposed surface 96 and the emission hole 98 in the opposed surface 96 is accurately opposed to the light-receiving hole 64 in the opposed surface 60.

In this way, in the first embodiment, since the protrusions 132 are disposed at plural positions on the opposed surface 96 of the image reader 84 and the positioning holes 82 are disposed at plural corresponding positions on the opposed surface 60 of the electronic cassette 12, it is possible to simply position the electronic cassette 12 at the communicable position without performing a complex positioning operation. In the first embodiment, one of the protrusion 132 and the positioning hole 82 corresponds to the first guiding member and the other corresponds to the second guiding member.

As described above, when the casing 20 of the electronic cassette 12 is moved downward when the opposed surface 60 of the casing 20 of the electronic cassette 12 is opposed to the opposed surface 96 of the casing 94 of the image reader 84 and the casing 20 of the electronic cassette 12 is located substantially above the communicable position, as shown in FIG. 5B, the case 134A of the connector 134 disposed on the opposed surface 96 of the image reader 84 is inserted into the case 76A of the connector 76 disposed in the casing 20 of the electronic cassette 12 and the end of the terminal 76B of the connector 76 elastically deforms the curved portion of the terminals 136 and 138 of the connector 134 to be inserted between the ends of the terminals 136 and 138. Accordingly, the end of the terminal 76B is nipped between the terminals 136 and 138 by the nipping force resulting from the elastic deformation of the curved portions of the terminals 136 and 138.

Since the terminals 76B of the connector 76 are nipped by the corresponding pairs of terminals 136 and 138 of the connector 134, respectively, the individual terminals 76B are electrically connected to the corresponding pairs of terminals 136 and 138 and the nipping force nipping the terminals 76B serves as the holding force for holding the casing 20 of the electronic cassette 12 at the communicable position against a force applied to move up the casing 20 of the electronic cassette 12 positioned at the communicable position. Accordingly, even when an external force such as a pressing force or vibration is applied to at least one of the casing 20 of the electronic cassette 12 and the casing 94 of the image reader 84 when the electronic cassette 12 and the image reader 84 make a communication with each other using a laser beam as described later, the relative position between the electronic cassette 12 and the image reader 84 is held in the communicable positional relation.

When the terminals 76B of the connector 76 are electrically connected to the corresponding terminals 136 and 138, the power is supplied to the LD power supply 74 of the electronic cassette 12 through the connectors 76 and 134 from the power supply unit 142 of the image reader 84 and thus the LD 52 of the electronic cassette 12 can emit a laser beam. Some of the power supplied to the LD power supply 74 from the power supply unit 142 is supplied to the LD power supply 144 of the image reader 84 through the connectors 76 and 134 and thus the LD 86 of the image reader 84 can also emit a laser beam.

When a user positions the electronic cassette 12 at the communicable position, the user instructs the image reader 84 to read the image data from the electronic cassette 12 by manipulating the keyboard 120 of the manipulation unit 116.

When it is instructed to read the image data, the communication controller 108 of the image reader 84 first determines whether the end of contactor 140A is pressed in accordance with the contact status of the limit switch 140. In the contactor 140A of the limit switch 140, when the electronic cassette 12 is accurately positioned at the communicable position and the opposed surface 60 of the casing 20 of the electronic cassette 12 comes in contact with the opposed surface 96 of the casing of the image reader 84, the end of the contactor 140A is pressed by the opposed surface 60. Accordingly, when determining that the end of the contactor 140A of the limit switch 140 is not pressed, the communication controller 108 displays an error message requesting for demounting the electronic cassette 12 from the image reader 84 and mounting the electronic cassette again on the display 118 without emitting the laser beam from the LD 86. Accordingly, when the opposed surface 60 of the electronic cassette 12 rises up from the opposed surface 96 of the image reader 84 for a certain reason, the communication using a laser beam is not made but the electronic cassette 12 should be set again.

When determining that the end of the contactor 140A is pressed, the communication controller 108 first controls the LD 86 to emit a small-power laser beam through the modulator 104. The small-power laser beam emitted from the LD 86 is emitted from the casing 94 of the image reader 84 through the emission hole 98, but when the laser beam is input into the casing 20 of the electronic cassette 12 through the light-receiving hole 64 and is detected (sensed) by the PD 56, the communication controller 72 of the image reader 84 controls the LD 52 to emit a small-power laser beam through the modulator 68. The small-power laser beam emitted from the LD 52 is emitted from the casing 20 of the electronic cassette 12 through the emission hole 62.

When the laser beam is input into the casing 94 of the image reader 84 through the light-receiving hole 100 and is detected (sensed) by the PD 90, the small-power laser beam emitted from the LD 86 of the image reader 84 is detected (sensed) by the PD 56 of the electronic cassette 12 and the small-power laser beam emitted from the LD 52 of the electronic cassette 12 is detected (sensed) by the PD 90 of the image reader 84. Accordingly, it can be determined that the relative position between the electronic cassette 12 and the image reader 84 is the optimal communicable position at which the laser beam emitted from the LD 86 is input to the center of the light-receiving surface of the PD 56 or the vicinity thereof and the laser beam emitted from the LD 52 is input to the center of the light-receiving surface of the PD 90 or the vicinity thereof.

Therefore, when the small-power laser beam is detected (sensed) by the PD 90, the communication controller 108 of the image reader 84 performs an opposite device checking process of checking whether the opposite device is a regular device by transmitting predetermined information from the relevant device using a laser beam (modulating the laser beam emitted from the LD of the relevant device on the basis of the predetermined information) and confirming the details of the information (information obtained by demodulating the laser beam emitted from the LD of the opposite device and received by the PD of the relevant device) received from the opposite device using the laser beam. An example of the information transmitted from the electronic cassette 12 to the image reader 84 in the opposite device checking process can include information such as a cassette ID for identifying the electronic cassette 12 and an example of the information transmitted from the image reader 84 to the electronic cassette 12 can include information indicating that the relevant device is an image reader.

The communication controller 108 of the image reader 84 performs an error process of stopping the emission of the laser beam from the LD 86 and displaying on the display 118 an error message indicating that the opposite device is not a regular device when determining that the opposite device is not a regular device in the opposite device checking process, or sets the power of the laser beam from the LD 86 to a value of the normal communication and transmits information requesting the opposite device for transmitting data to the opposite device using the laser beam when determining that the opposite device is a regular device (the electronic cassette 12) in the opposite device checking process.

When receiving the information requesting for transmitting data from the image reader 84, the communication controller 72 of the electronic cassette 12 sets the power of the laser beam from the LD 52 to the value of the normal communication, reads image data, which is not transmitted to the image reader 84, as the image data to be transmitted from the image memory 50, and transmits the image data read from the image memory 50 to the opposite device (the image reader 84) using a laser beam. When the image data transmitted from the electronic cassette 12 using the laser beam is received by the image reader 84, the communication controller 108 of the image reader 84 outputs the image data received from the opposite device (the electronic cassette 12) to a rear stage (the image processor 122 in this embodiment). Accordingly, the image data received by the image reader 84 is subjected to various image processes by the image processor 122 and then is stored in the image memory 124. The communication controller 108 of the image reader 84 transmits a response to the transmission of data from the opposite device (the electronic cassette 12) using a laser beam. When the response is received by the electronic cassette 12, the communication controller 72 of the electronic cassette 12 performs again the reading of non-transmitted image data from the image memory 50 and the transmitting of the read image data.

The above-mentioned sequence is repeated until the image data not transmitted to the image reader 84 does not remain in the image memory 50 and all the non-transmitted image data stored in the image memory 50 is transmitted to the image reader 84. When the non-transmitted image data does not remain in the image memory 50, the communication controller 72 of the electronic cassette 12 notifies the opposite device (the image reader 84) of the end of data transmission and stops the emission of the laser beam from the LD 52. When the end of data transmission is notified, the communication controller 108 of the image reader 84 stops the emission of the laser beam from the LD 86 and displays a message indicating that the reading of image data from the electronic cassette 12 is ended on the display 118.

As described above, when a force greater than the holding force due to the coupling of the connectors 76 and 134 is applied to the casing 20 of the electronic cassette 12 and the casing 20 of the electronic cassette 12 is displaced from the communicable position in the course of making a communication between the electronic cassette 12 and the image reader 84, the coupling of the connectors 76 and 134 is released and the supply of power from the power supply unit 142 of the image reader 84 to the LD power supply 74 of the electronic cassette 12 and the supply of power from the LD power supply 74 of the electronic cassette 12 to the LD power supply 144 of the image reader 84 are stopped. Accordingly, the supply of power to the LD 52 and the LD 86 is also stopped and the emission of the laser beam from the LD 52 and the LD 86 is stopped.

When the pressing of the opposed surface of the electronic cassette 12 on the end of the contactor 140A of the limit switch 140 is released with the displacement of the casing 20 of the electronic cassette 12 from the communicable position, the communication controller 108 of the image reader 84 senses the displacement of the casing 20 of the electronic cassette 12 and the communication controller 108 controls to stop the emission of the laser beam from the LD 86 and performs the error process of displaying the error message on the display 118.

### Second Embodiment

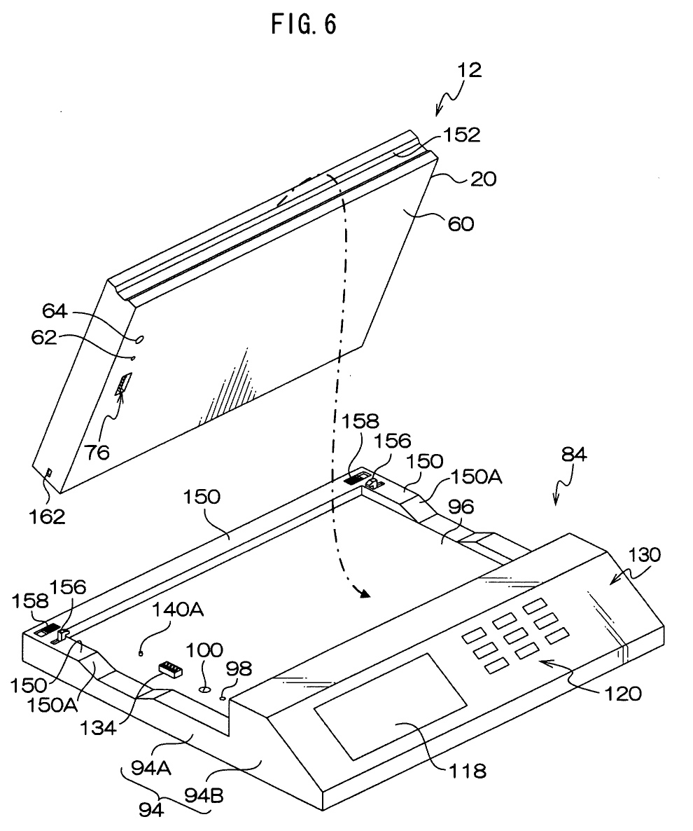

A second embodiment of the invention is described below. The same elements as the first embodiment are referenced by the same reference numerals and description thereof are omitted. As shown in FIG. 6, in the second embodiment, the protrusions 132 and the positioning holes 82 are omitted and an edge guide portion 150 having a height greater than that of the opposed surface 96 is provided around three sides of the opposed surface 96 other than the side close to the main body section 94B in the mounting section 94A of the casing 94 of the image reader 84. Cutout portions 150A are formed by partially cutting out portions of the edge guide portion 150 close to a pair of short sides of the opposed surface 96.

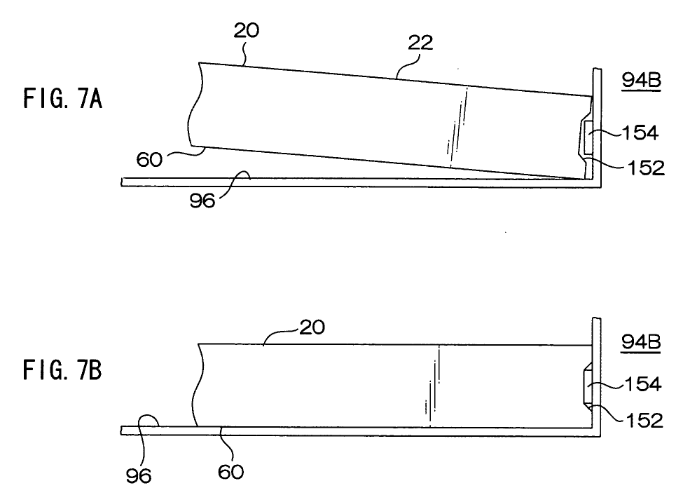

A groove 152 in the longitudinal direction of the corresponding side surface is formed in a specific side surface, which is close to the main body section 94B of the image reader 84 when it is positioned at the communicable position, among the side surfaces of the casing 20 of the electronic cassette 12. As shown in FIGS. 7A and 7B, a protrusion 154 inserted into the groove 152 when the casing 20 of the electronic cassette 12 is positioned at the communicable position is formed in the rear surface, which is close to the specific side surface when the casing 20 of the electronic cassette 12 is positioned at the communicable position, in the main body section 94B of the image reader 84.

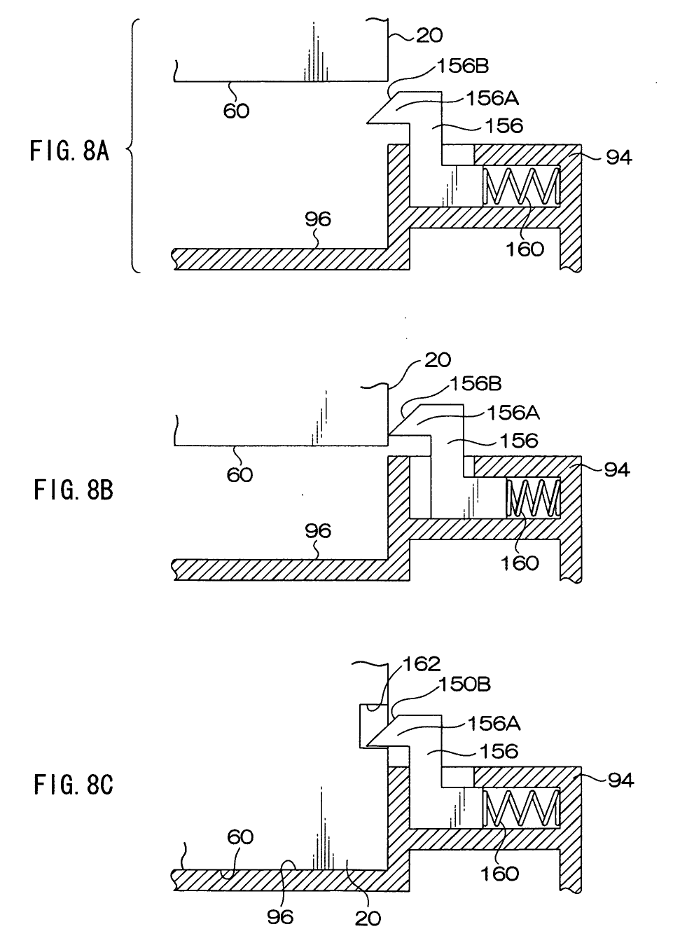

In addition, a holding member 156 is disposed in the vicinity of the positions of the cutout portions 150A in the edge guide portion 150. As shown in FIG. 8, the holding member 156 includes a protruded portion 156A protruding to the space above the opposed surface 94 and having a slope 156B on the top surface thereof so that the thickness gradually decreases from the base to the end. The holding member 156 is connected to a slider 158 (see FIG. 6) disposed in the vicinity of the holding member 156. The holding member 156 and the slider 158 can slidably move between a position at which the protruded portion 156A protrudes to the space above the opposed surface 94 and a position (position shown in FIG. 8B) where the protruded portion 156A evacuates from the space above the opposed surface 94. A compression coil spring 160 is interposed between the end of the holding member 156 opposite to the protruding direction of the protruded portion 156A and the casing 94 of the image reader 84 and the holding member 156 and the slider 158 are held at the position shown in FIG. 8A with the urging force of the compression coil spring 160.

A groove 162 into which the end of the protruded portion 156A when the casing 20 of the electronic cassette 12 is positioned at the communicable position is inserted is formed at a position, which comes in contact with the end of the protruded portion 156A of the holding member 156 when the casing 20 of the electronic cassette 12 is positioned at the communicable position, on the side surface of the casing 20 of the electronic cassette 12.

The positioning operation of the electronic cassette 12 at the communicable position according to the second embodiment is described below. When the image data stored in the image memory 50 of the electronic cassette 12 is read by the image reader 84, a user first grasps the casing 20 of the electronic cassette 12 storing the image data to be read with the opposed surface 60 directed downward and moves the casing to the space above the mounting section 94A of the image reader 84. Then, the user tilts the casing of the electronic cassette 12 so that the specific side surface having the groove 152 in the casing 20 of the electronic cassette 12 is lower than the opposite side surface and moves the casing 20 of the electronic cassette 12 while adjusting the position in the longitudinal direction of the opposed surface 60 of the casing 20 of the electronic cassette 12, so that a first side interposed between the specific side surface having the groove 152 in the casing 20 of the electronic cassette 12 and the opposed surface 60 is inserted between a pair of edge guide portions 150 disposed at both ends in the longitudinal direction of the opposed surface 96 of the image reader 84 and the side comes in contact with the opposed surface 96 of the image reader 84 over the entire length thereof

When the first side of the casing 20 of the electronic cassette 12 interposed between the specific side surface and the opposed surface 60 comes in contact with the opposed surface 96 of the image reader 84 over the entire length thereof, the user slidably moves the casing 20 of the electronic cassette 12 over the opposed surface 96 of the image reader 84, so that a second side interposed between the specific side surface and the irradiated surface 22 in the casing 20 of the electronic cassette 12 comes in contact with the rear surface of the main body section 94 of the image reader 84 over the entire length (the state shown in FIG. 7A). Then, when the second side of the casing 20 of the electronic cassette 12 comes in contact with the rear surface of the main body section 94 of the image reader 84 over the entire length, the user rotates the end, opposite to the specific side surface, of the casing 20 of the electronic cassette 12 downward about the first side or the second side of the casing 20. Accordingly, the entire casing 20 of the electronic cassette 12 is inserted into the edge guide portions 150 and the electronic cassette 12 is accurately positioned at the communicable position on the opposed surface 96 by bringing the opposed surface 60 into contact with the opposed surface 96. As a result, the emission hole 62 of the opposed surface 60 is accurately opposed to the light-receiving hole 100 of the opposed surface 96 and the emission hole 98 of the opposed surface 96 is accurately opposed to the light-receiving hole 64 of the opposed surface 60.

In this way, in the second embodiment, the edge guide portions 150 are disposed at the edges of the opposed surface 96 of the image reader 84. Accordingly, when the casing 20 of the electronic cassette 12 is erroneously located at a position departing from the communicable position, the opposed surface of the electronic cassette 12 comes in contact with the top surface of the edge guide portions 150 to prevent the casing 20 of the electronic cassette 12 from further moving downward. Accordingly, it is possible to allow the user to recognize that the casing 20 of the electronic cassette 12 departs from a predetermined position for positioning it at the communicable position and to accurately position the electronic cassette 12 at the communicable position with a simple operation of inserting the electronic cassette 12 into the edge guide portions 150 so that the opposed surface of the electronic cassette 12 does not come in contact with the top surface of the edge guide portions 150. In the second embodiment, one of the edge guide portions 150 and the opposed surface 60 or the side surface of the casing 20 of the electronic cassette 12 corresponds to the first guiding member and the other corresponds to the second guiding member.

As described above, when the end, opposite to the specific side surface, of the casing 20 of the electronic cassette 12 is rotated downward about the first side or the second side of the casing 20 when the second side of the casing 20 of the electronic cassette 12 comes in contact with the rear surface of the main body section 94 of the image reader 84 over the entire length, the corner of the casing 20 first comes in contact with the slope 156B of the protruded portion 156A of the holding member 156 from the state shown in FIG. 8A and the holding member 156 and the slider 158 slidably move against the urging force of the compression coil spring 160 to the position (position shown in FIG. 8B) where the protruded portion 156A evacuates from the space above the opposed surface 94 with the further downward movement of the casing 20. When the casing 20 is being moved downward, the end of the protruded portion 156A is contacted and pressed by the side surface of the casing 20, whereby it is held at the position after the sliding movement.

When the opposed surface 60 comes in contact with the opposed surface 96 and the electronic cassette 12 is positioned at the communicable position on the opposed surface 96, as shown in FIG. 8C, the groove 162 disposed in the side surface of the casing 20 is flush with the end of the protruded portion 156A. Accordingly, the holding member 156 and the slider 158 slides to the normal position (the position at which the protruded portion 156A protrudes to the space above the opposed surface 94) with the urging force of the compression coil spring 160 and the end of the protruded portion 156A is inserted into the groove 162. When the opposed surface 60 comes in contact with the opposed surface 96 and the electronic cassette 12 is positioned at the communicable position on the opposed surface 96, as shown in FIG. 7B, the protrusion 154 formed on the rear surface of the main body section 94B of the image reader 84 is inserted into the groove 152 disposed in the specific side surface of the casing 20 of the electronic cassette 12.

The engagement between the end of the protruded portion 156A of the holding member 156 and the groove 162 and the engagement of the protrusion 154 and the groove 152 are held while the electronic cassette 12 is positioned at the communicable position on the opposed surface 96. Accordingly, even when an external force such as a pressing force or a vibration is applied to at least one of the casing 20 of the electronic cassette 12 and the casing 94 of the image reader 84 when the electronic cassette 12 and the image reader 84 make a communication with each other using a laser beam, the relative position between the electronic cassette 12 and the image reader 84 is held in the communicable positional relation.

In the second embodiment, the electronic cassette 12 can be demounted from the communicable position by slidably moving the slider 158 (and the holding member 156) against the urging force of the compression coil spring 160 so that the end of the protruded portion 156A evacuates from the groove 162, nipping the side surface of the casing 20 of the electronic cassette 12 at the positions where the cutout portions 150A are formed in this state, and moving the end opposite to the side surface of the casing 20 having the groove 152 upward.

### Third Embodiment

A third embodiment of the invention is described below. The same elements as the first embodiment and the second embodiment are referenced by the same reference numerals and description thereof are omitted.

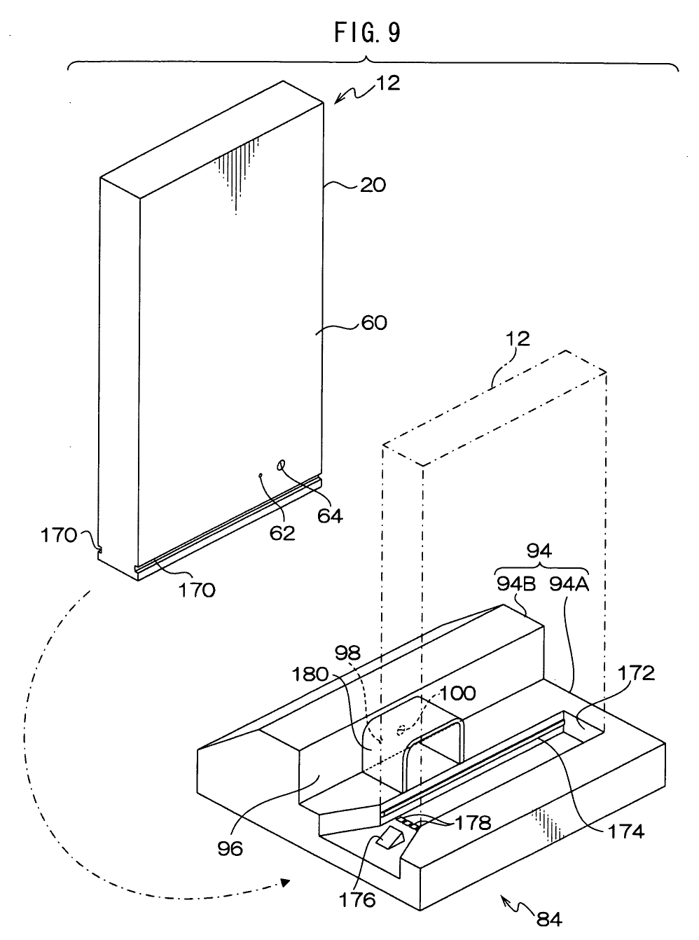

As shown in FIG. 9, in the third embodiment, the rear surface of the main body section 94B of the image reader 84 is used as the opposed surface 96 and the emission hole 98 and the light-receiving hole 100 are formed in the opposed surface. The electronic cassette 12 according to the third embodiment is set to the image reader 84 when a specific side surface (the specific side surface is referred to as “bottom surface” in the third embodiment), which meets the short sides of the opposed surface 60, of the side surfaces of the casing 20 of the electronic cassette 12 is adjusted to face the downside and the opposed surface 60 is adjusted to be opposed to the opposed surface 96. In the opposed surface 60 and the irradiated surface 22 of the casing 20 of the electronic cassette 12, grooves 170 parallel to the short sides of the opposed surface 60 and the irradiated surface 22 are formed in the vicinity of the end meeting the bottom surface.

In the mounting section 94A of the image reader 84, an insertion groove 172 for inserting the bottom surface of the casing 20 at the time of setting the electronic cassette 12 is formed parallel to the opposed surface 96. The insertion groove 172 is opened at one end of the mounting section 94A and protrusions 174 engaging with the grooves 170 of the casing 20 at the time of inserting the casing 20 of the electronic cassette 12 from the opening of the insertion groove 172 are disposed on both side walls in the longitudinal direction of the insertion groove 172. In the third embodiment, the bottom surface of the casing 20 of the electronic cassette 12 is inserted into the insertion groove 172 from the opening of the insertion groove 172 and the position (the position indicated by a one-dot chained line in FIG. 9) where the casing 20 slides to the deep side (opposite side of the opening) of the insertion groove 172 until it comes in contact with the deepest portion of the insertion groove 172 is the communicable position. To easily insert the casing 20 into the insertion groove 172, the width of the insertion groove 172 gradually increases from the opening to the end of the mounting section 94A to form a tapered shape.

A stopper 176 is disposed at an exposed position of the bottom surface of the insertion groove 172 when the casing 20 of the electronic cassette 12 slides to the communicable position. The stopper 176 has a first slope having a small angle difference from the bottom surface of the insertion groove 172 on the opening side of the insertion groove 172 and a second slope perpendicular or substantially perpendicular to the bottom surface of the insertion groove 172 on the deep side of the insertion groove 172, normally protrudes from the bottom surface of the insertion groove 172 with an urging force of an urging member not shown, and evacuates (moves) to a position flush with the bottom surface of the insertion groove 172 when a pressing force greater than the urging force of the urging member is applied thereto from the upside.

On the bottom surface of the insertion groove 172, plural electrodes 178 are disposed at positions opposed to the bottom surface of the electronic cassette 12 when the casing 20 of the electronic cassette 12 slides to the communicable position. The electrodes 178 normally protrude from the bottom surface of the insertion groove 172 by a predetermined height with an urging force of an urging member not shown, similarly to the stopper 176, and evacuates (moves) to a position flush with the bottom surface of the insertion groove 172 when a pressing force greater than the urging force of the urging member is applied thereto. Although not shown, plural electrodes coming in contact with one of the plural electrodes 178 when the casing 20 of the electronic cassette 12 slides to the communicable position are disposed on the bottom surface of the electronic cassette 12. With this contact between the electrodes, the LD power supply 74 of the electronic cassette 12 is electrically connected to the power supply unit 142 and the LD power supply 144 of the image reader 84 when the casing 20 of the electronic cassette 12 is positioned at the communicable position.

In the third embodiment, a gap is formed between the opposed surface 60 of the electronic cassette 12 and the opposed surface 96 of the image reader 84 when the casing 20 of the electronic cassette 12 slides to the communicable position, but the top surface of the mounting section 94A is provided with a cover 180 covering an optical path of a laser beam extending from the emission hole 62 of the electronic cassette 12 to the light-receiving hole 100 of the image reader 84 and an optical path of a laser beam extending from the emission hole 98 of the image reader 84 to the light-receiving hole 64 of the electronic cassette 12 when the casing 20 of the electronic cassette 12 slides to the communicable position. The cover 180 may be formed of an opaque material or a colored transparent material.

The positioning operation of the electronic cassette 12 at the communicable position according to the third embodiment is described below. When the image data stored in the image memory 50 of the electronic cassette 12 is read by the image reader 84, a user first grasps the casing 20 of the electronic cassette 12 storing the image data to be read with the bottom surface directed downward, moves the casing 20 in a sliding manner, inserts the bottom surface of the casing 20 into the insertion groove 172 of the image reader 84 from the opening of the insertion groove 172 when the casing 20 of the electronic cassette 12 is directed so that the opposed surface 60 is opposed to the opposed surface 96, and moves the casing 20 to the deep side of the insertion groove 172 in a sliding manner until the casing 20 comes in contact with the deepest portion of the insertion groove 172. Accordingly, the casing 20 of the electronic cassette 12 is positioned at the communicable position indicated by a one-dot chained line in FIG. 9.

In the third embodiment, the insertion groove 172 for insertion of the bottom surface of the casing 20 at the time of setting the electronic cassette 12 is disposed in the mounting section 94A of the casing 94 of the image reader 84 and the protrusions 174 engaging with the grooves 170 of the casing 20 of the electronic cassette 12 are disposed on the side walls of the insertion groove 172. Accordingly, it is possible to accurately position the electronic cassette 12 at the communicable position with a simple operation of inserting the bottom surface of the casing 20 into the insertion groove 172 and moving the casing 20 to the deep side of the insertion groove 172 in a sliding manner until the casing 20 comes in contact with the deepest portion of the insertion groove 172. In the third embodiment, one of the insertion groove 172 and the bottom surface of the casing 20 and one of the grooves 170 and the protrusions 174 correspond to the first guiding member and the others correspond to the second guiding member.

When the bottom surface of the casing 20 is being inserted into the insertion groove 172 and the casing 20 is being moved to the deep side of the insertion groove 172 in a sliding manner, the first slope of the stopper 176 is contacted and pressed by the bottom surface of the casing 20 and evacuates to the position flush with the bottom surface of the insertion groove 172. When the casing 20 of the electronic cassette 12 comes in contact with the deepest portion of the insertion groove 172 to reach the communicable position, the bottom surface of the casing 20 does not come in contact with the stopper 176 and thus the stopper 176 is restored to the position protruding from the bottom surface of the insertion groove 172 with the urging force of the urging member. Accordingly, in the relative movement of the electronic cassette 12 and the image reader 84 reaching the communicable position, the relative movement in the opposite direction of the insertion direction of the casing 20 into the insertion groove 172 is prevented by the contact of the second slope of the stopper 176 with the casing 20 and the relative movement in the other direction is prevented by the engagement of the protrusions 174 with the grooves 170 and the contact of the casing 20 with the deepest portion of the insertion groove 172. Accordingly, even when an external force such as a pressing force or vibration is applied to at least one of the casing 20 of the electronic cassette 12 and the casing 94 of the image reader 84 when the electronic cassette 12 and the image reader 84 make a communication with each other using a laser beam, the relative position between the electronic cassette 12 and the image reader 84 is held in the communicable positional relation.

Since the optical path of a laser beam between the opposed surface 60 of the electronic cassette 12 and the opposed surface 96 of the image reader 84 when the casing 20 of the electronic cassette 12 is positioned at the communicable position is covered with the cover 180, it is possible to improve the safety. In the third embodiment, the electronic cassette 12 can be demounted from the communicable position by moving the casing of the electronic cassette 12 in a sliding manner in the opposite direction of the insertion direction of the insertion groove 172 when the stopper 176 is pressed to be flush with the bottom surface of the insertion groove 172.

### Fourth Embodiment

A fourth embodiment of the invention is described below. The same elements as the second embodiment and the third embodiment are referenced by the same reference numerals and description thereof are omitted.

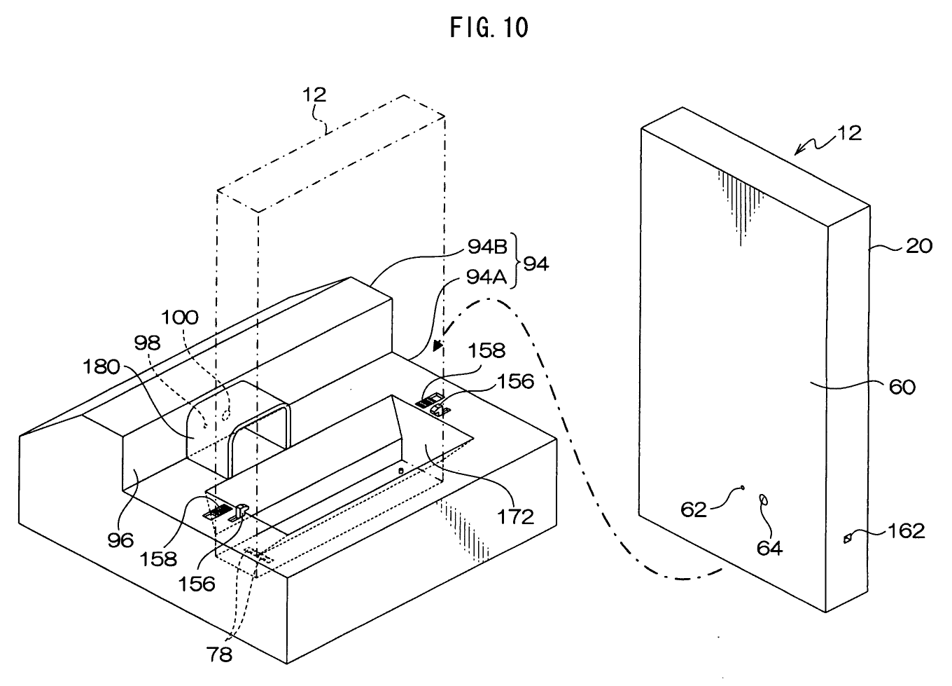

As shown in FIG. 10, the fourth embodiment is different from the third embodiment, in the insertion direction of the casing 20 of the electronic cassette 12 into the insertion groove 172. That is, the casing 20 of the electronic cassette 12 according to the fourth embodiment is not provided with the groove 170 described in the third embodiment and the side wall of the insertion groove 172 is not provided with the protrusion 174 described in the third embodiment. The insertion groove 172 is not opened at one end of the mounting section 94A and is deeper than the insertion groove 172 described in the third embodiment. To easily insert the casing 20 into the insertion groove 172 from the upside, the width of the insertion groove 172 gradually increases from a predetermined height position from the bottom surface of the insertion groove 172 to the top surface of the mounting section 94A to form a tapered shape.

In the fourth embodiment, the stopper 176 described in the third embodiment is omitted and instead, the holding member 156 and the slider 158 described in the second embodiment are disposed in the vicinity of both ends in the longitudinal direction of the insertion groove 172 on the top surface of the mounting section 94A. The holding member 156 is disposed so that the protruded portion 156A protrudes to the space above the insertion groove 172. In addition, a groove 162 is formed at a position, which comes in contact with the end of the protruded portion 156A of the holding member 156 when the casing 20 is positioned at the communicable position (the position at which the casing 20 is inserted up to the bottom surface of the insertion groove 172 so that the entire bottom surface of the casing 20 comes in contact with the bottom surface of the insertion groove 172), on the side surface of the casing 20 of the electronic cassette 12.

The positioning operation of the electronic cassette 12 at the communicable position according to the fourth embodiment is described below. When the image data stored in the image memory 50 of the electronic cassette 12 is read by the image reader 84, a user first grasps the casing 20 of the electronic cassette 12 storing the image data to be read with the bottom surface directed downward, moves the casing 20 in a sliding manner, and inserts the casing 20 into the insertion groove 172 from the upside of the insertion groove 172 until the entire bottom surface of the casing 20 comes in contact with the bottom surface of the insertion groove 172 when the casing 20 of the electronic cassette 12 is directed so that the opposed surface 60 is opposed to the opposed surface 96. Accordingly, the casing 20 of the electronic cassette 12 is positioned at the communicable position indicated by a one-dot chained line in FIG. 10.

In the fourth embodiment, the insertion groove 172 for insertion of the bottom surface of the casing 20 at the time of setting the electronic cassette 12 is disposed in the mounting section 94A of the casing 94 of the image reader 84. Accordingly, it is possible to accurately position the electronic cassette 12 at the communicable position with a simple operation of inserting the casing 20 into the insertion groove 172 from the upside of the insertion groove 172. In the fourth embodiment, one of the insertion groove 172 and the bottom surface of the casing 20 corresponds to the first guiding member and the other corresponds to the second guiding member.

When the electronic cassette 12 is positioned at the communicable position, the holding member 156 and the slider 158 being pressed by the side surface of the casing 20 to slide to the position at which the protruded portion 156A evacuates from the space above the insertion groove 172 slides to the normal position (the position at which the protruded portion 156A protrudes to the space above the insertion groove 172) with the urging force of the compression coil spring 160 due to the height of the groove 162 disposed in the side surface of the casing 20 and equal to the height of the end of the protruded portion 156A, whereby the end of the protruded portion 156A is inserted into the groove 162. Accordingly, even when an external force such as a pressing force or vibration is applied to at least one of the casing 20 of the electronic cassette 12 and the casing 94 of the image reader 84 when the electronic cassette 12 and the image reader 84 make a communication with each other using a laser beam, the relative position between the electronic cassette 12 and the image reader 84 is held in the communicable positional relation by the engagement of the groove 162 with the end of the protruded portion 156A of the holding member 156.

The aspect in which the protrusion 132 and the positioning hole 82 are disposed at plural positions is described in the first embodiment, but the invention is not limited to the configuration. By setting the opening of the positioning hole in a non-circular shape and setting the protrusion to correspond to the opening shape of the positioning hole, it is possible to prevent the relative rotation of the electronic cassette 12 and the image reader 84 even when the protrusion and the positioning hole are disposed at only one position, thereby accurately positioning the relative position between the electronic cassette 12 and the image reader 84 at the communicable position.

The guiding of the relative position between the electronic cassette 12 and the image reader 84 to the communicable position can be embodied by the engagement of the protrusion 132 and the positioning hole 82 in the first embodiment, by the contact of the edge guide portion 150 and the casing 20 of the electronic cassette 12 in the second embodiment, by the contact of the insertion groove 172 and the bottom surface of the casing 20 and the engagement of the groove 170 and the protrusion 174 in the third embodiment, and by the contact of the insertion groove 172 and the bottom surface of the casing 20 in the fourth embodiment, but the invention is not limited to the configurations. Any one of various known techniques applicable for guidance to the communicable position may be employed.

The prevention of the relative displacement of the electronic cassette 12 and the image reader 84 after the relative position between the electronic cassette 12 and the image reader 84 is temporarily adjusted to the communicable position can be embodied by the coupling of the connectors 76 and 134 in the first embodiment, by the engagement of the end of the protruded portion 156A and the groove 162 and the engagement of the protrusion 154 and the groove 152 in the second embodiment, by the contact of the stopper 176 and the casing 20, the engagement of the groove 170 and the protrusion 174, and the contact of the casing 20 and the deepest portion of the insertion groove 172 in the third embodiment, and by the engagement of the end of the protruded portion 156A and the groove 162 in the fourth embodiment, but the invention is not limited to the configurations. Various known techniques may be employed for the prevention of the relative displacement. For example, a configuration may be employed in which a metal member is disposed in one device and an electromagnet attaching the metal member is disposed to the other device, whereby the relative displacement can be prevented by attracting the metal member with the electromagnet.

A partial area including the periphery of the light-receiving hole 64 (and the emission hole 62) on the opposed surface 60 of the casing 20 of the electronic cassette 12 and a partial area including the periphery of the light-receiving hole 100 (and the emission hole 98) on the opposed surface 96 of the casing 94 of the image reader 84 may be covered with a diffusing member diffusing the reflected beam of the laser beam by reflecting the radiated laser beam in plural different directions. As the diffusing member, a member can be used, the surface of which is shaped so that plural portions having different reflecting directions of the laser beam exists in a small area having an area smaller than that of the irradiated area of the laser beam. Accordingly, it is possible to satisfactorily diffuse the reflected beam of the laser beam. As the diffusion member, a member having a shaped surface can be preferably used, the surface of which is shaped so that semi-spherical convex portions are uniformly distributed on the surface with substantially 1/10 or less of the wavelength of the laser beam. It is possible to reduce the incident angle dependence by setting the convex portions in the semi-spherical shape and to further markedly scatter the laser beam due to the Rayleigh scattering area by setting the size of the individual convex portions to substantially 1/10 or less of the wavelength of the laser beam.

Instead of the above-mentioned diffusing member, an absorbing member (for example, an optical filter having the wavelength selectivity (specifically, a light absorbing filter having the light absorbing property in the wavelength range of the laser beam) or a hair transplanting member or a porous member, or a member having a black surface) absorbing most of the applied laser beam may be employed. For example, with a configuration in which a light absorbing material is dispersed in a nitric material, a light absorbing filter having transmittance of about 20% (the optical attenuation ratio per unit length of 1 mm of the optical path is 80%) for the light having a wavelength of 1300 nm which is the wavelength of the laser beam suitable for the communication between the electronic cassette 12 and the image reader 84 is brought to the market. Accordingly, by using the light absorbing filter or performing an AR coating operation on the surface of a light absorbing filter to suppress the surface reflection, the absorbing member suppressing the reflected light to several percentages of the incident light can be embodied.

When the partial areas including the peripheries of the light-receiving hole (and the emission hole) on the opposed surfaces 60 and 96 are covered with the diffusing member or the absorbing member and when the relative position is changed for a certain reason during the communication between the electronic cassette 12 and the image reader 84 and the laser beam emitted from the electronic cassette 12 or the image reader 84 is applied to a position departing from the light-receiving hole on the opposed surface of the opposite device, the laser beam of which the applied position departs from the light-receiving hole is applied to the absorbing member and most thereof is absorbed by the absorbing member. Accordingly, it is possible to greatly suppress the intensity of the laser beam leaking from the space interposed between the opposed surface 60 of the electronic cassette 12 and the opposed surface 96 of the image reader 84.

When an invisible laser beam having a wavelength outside the visible region is used in the communication between the electronic cassette 12 and the image reader 84, the partial area may be covered with a light-emitting (fluorescent) member of which the irradiated portion emits light in the visible range with the application of the invisible laser beam, instead of the diffusing member or the absorbing member. For example, when the wavelength of the laser beam is in the infrared range, a near-infrared optical path checking fluorescent sheet (LASER DETECTION CARD IR) made by Edmund Optics Corporation can be used as the light-emitting (fluorescent) member. When the light-emitting (fluorescent) member is provided instead of the diffusing member or the absorbing member, the effect of reducing the intensity of the laser beam cannot be obtained, unlike the diffusing member or the absorbing member. However, when the relative position is changed for a certain reason during the communication between the electronic cassette 12 and the image reader 84 and the invisible laser beam emitted from the electronic cassette 12 or the image reader 84 is applied to a position departing from the light-receiving hole on the opposed surface of the opposite device, it is possible to allow a user to recognize that the applied position of the invisible laser beam departs from the light-receiving hole and the invisible laser beam may leak from the space between the opposed surface 60 of the electronic cassette 12 and the opposed surface 96 of the image reader 84, by allowing the invisible laser beam, the applied position of which departs from the light-receiving hole, to be applied to the light-emitting (fluorescent) member and allowing the light-emitting (fluorescent) member to emit a beam (a visible beam). Accordingly, it is possible to allow the user to take a countermeasure for avoiding the leaked invisible laser beam from being applied to a specific portion (a portion to which the laser beam should not be applied) other than the space.

Considering that the relative position between the electronic cassette 12 and the image reader 84 may be changed for a certain reason during the communication between the electronic cassette 12 and the image reader 84, by monitoring at least one of a deterioration in reception status in receiving the transmission information from the opposite device, a change in distance from the casing (housing) of the opposite device, and an application of a laser beam to the periphery of the light-receiving hole on the opposed surface and at least stopping the emission of the laser beam, lighting a lamp, ringing a buzzer, or displaying an alarming message on the display 118 when at least one of the deterioration in reception status, the change in distance from the casing of the opposite device, and the application of a laser beam to the periphery of the light-receiving hole is detected, it is preferable to issue an alarm to a user to attract the user's attention. Accordingly, even when the relative position between the electronic cassette 12 and the image reader 84 is changed for a certain reason during the communication between the electronic cassette 12 and the image reader 84, it is possible to secure the safety.

The deterioration in reception status may be detected on the basis of the change in received intensity of a laser beam from the opposite device to the PD of the relevant device, or may be detected on the basis of an error rate (for example, the frequency of requesting the opposite device for retransmission of information or the frequency of correcting an error of the received information) in receiving information using a laser beam from the opposite device. The application of a laser beam to the periphery of the light-receiving hole may be detected by providing a single or plural photoelectric conversion device (for example, PD) to the vicinity of the light-receiving hole.

The distance from the casing of the opposite device may be detected on the basis of the time from the emission of light from a light-emitting element to the reflection of the emitted light from the casing of the opposite device and the reception of the light in the light-receiving element, or may be detected by a triangulation principle based on the reception position of light in the light-receiving element. The distance from the casing of the opposite device may be detected by providing the opposite device with an electric field generator generating a constant intensity of electric field or a magnetic field generator generating a constant intensity of magnetic field and detecting the intensity of the electric field or the magnetic field generated from the electric field generator or the magnetic field generator of the opposite device. As described in the first embodiment and the second embodiment, when the casing of the electronic cassette 12 and the casing of the image reader 84 come in contact with each other at the communicable position, the change in distance (whether the contact with the casing of the opposite device is released) from the casing of the opposite device may be detected by the use of the limit switch. When the devices making a communication using a laser beam include a radio communication unit making a radio communication using an electromagnetic wave other than the laser beam and the radio communication of the radio communication unit employs a communication scheme (for example, a radio communication based on the IrDA standard using infrared) in which a distance between communicable devices or a positional relation between the devices is defined or the communication quality is greatly changed depending on the distance between the devices or the positional relation between the devices, it may be possible to acquire information such as the intensity of the electromagnetic wave from the opposite device detected by the radio communication unit or the error rate (for example, the frequency of requesting the opposite device for retransmission of information or the frequency of correcting an error of the received information) of the radio communication and to estimate whether the distance from the opposite device (positional relation with the opposite device) is changed to an extent (greater than a threshold value) to influence the intensity of the electromagnetic wave or the error rate of the radio communication on the basis of the acquired information.

Although it has been described that the electronic cassette 12 and the image reader 84 as the electronic devices according to the invention emit a laser beam to communicate with each other, one of the devices making a communication may emit a laser beam to transmit information and the other may transmit information by the use of an additional communication unit (for example, infrared). In this case, considering that a very high transfer rate is embodied in the radio communication using an infrared laser beam, an device (for example, the electronic cassette transmitting image data among the electronic cassette and the image reader) transmitting a greater amount of information is preferably selected as the device emitting a laser beam to transmit information.

Although the electronic cassette 12 (a portable radiographic image converter) and the image reader 84 have been exemplified as a suitable electronic device according to the invention, the invention is not limited to the devices, but may be applied to any electronic device making a radio communication with another device. Particularly, considering that a very high transfer rate is embodied in the radio communication using an infrared laser beam, the invention can be suitably applied to electronic devices of which at least one has the portability and which transmit and receive a great amount of data by the radio communication or have a high need for transmitting and receiving a great amount of data. For example, an image pickup apparatus such as a digital still camera or a digital video camera and an apparatus such as a PC or printer receiving still image data or moving image data from the image pickup apparatus may be selected as the electronic devices according to the invention and the radio communication therebetween may be made using a laser beam. A scanner having the portability and an apparatus such as a PC or a printer receiving still image data from the scanner may be selected as the electronic devices according to the invention and the radio communication therebetween may be made using a laser beam. Portable devices (such as mobile phone or PDA) having at least one of a function of taking a still image or a moving image and a function of reproducing music may be selected as the electronic devices according to the invention and the radio communication for exchanging image data or music data between the portable devices may be made using a laser beam.

1. A communication system comprising:
a first device comprising,
a first housing that comprises a first guiding member,
a modulator that modulates a laser beam in accordance with transmission information, and
an emission unit that emits the laser beam that has been modulated at the modulator; and
a second device comprising,
a second housing that comprises a light-receiving region on an outer surface of the second housing,
a receiver that, when a relative position between the first and the second housings is adjusted to a communicable position at which the modulated laser beam is incident within the light-receiving region, receives the transmission information from the first device by detecting the modulated laser beam and demodulating the transmission information based on the detection result, and
a second guiding member that is disposed on the second housing and guides the first and the second housings to the communicable position by contacting the first guiding member.

2. The communication system according to claim 1, wherein:
the second guiding member is a protruded portion that protrudes from the outer surface of the second housing; and
the first guiding member, when the relative position between the first and the second housings is adjusted to the communicable position at which the modulated laser beam is incident within the light-receiving region, is disposed on a surface of the first housing that is opposed to the second housing at a position which corresponds to the protruded portion, and comprises a concave portion into which the protruded portion fits.

3. The communication system according to claim 2, wherein the first and the second guiding members are respectively disposed at a plurality of positions, or the protruded portion has a columnar shape with a non-circular cross-section and the concave portion has a cross-sectional shape corresponding to that of the protruded portion.

4. The communication system according to claim 1, wherein
the second guiding member comprises a contact surface that contacts with the first guiding member when the relative position between the first and the second housings is adjusted to the communicable position at which the modulated laser beam is incident within the light-receiving region.

5. The communication system according to claim 4, wherein the second guiding member is disposed at a plurality of positions, and comprises
a first contact surface that contacts with an end surface of the first housing aligned along a first direction that intersects an emission direction of the modulated laser beam, and
a second contact surface that contacts with an end surface of the first housing aligned along a second direction that intersects both the emission direction and the first direction.

6. The communication system according to claim 1, wherein
the second guiding member, when the relative position between the first and the second housings is adjusted to the communicable position at which the modulated laser beam is incident within the light-receiving region:
is formed on a surface of the second housing that is opposed to the first housing; comprises an opening portion that accommodates a surface of the first housing that is opposed to the second housing; and comprises a concave portion having a side surface that contacts with an end portion of the first housing.

7. The communication system according to claim 1, further comprising, when the relative position between the first and the second housings is adjusted to the communicable position at which the modulated laser beam is incident within the light-receiving region, a cover section concealing an optical path of the modulated laser beam, which is emitted from the emission unit to the light-receiving region, from the outside.

8. The communication system according to claim 1, wherein the second device further comprises,
a reception status detector that detects deterioration in reception status of the transmission information; and
a first controller that issues an alarm or stops the emission of the modulated laser beam when the deterioration in reception status is detected by the reception status detector.

9. The communication system according to claim 1, wherein the second device further comprises,
a distance detector that detects or estimates variation of distance between the first device and the second device; and
a second controller that issues an alarm or stops the emission of the modulated laser beam when variation of the distance is detected or estimated by the distance detector.

10. The communication system according to claim 1, wherein the second device further comprises,
a laser beam detector that is disposed in at least a peripheral area of the light-receiving region on the outer surface of the second housing, and that detects the modulated laser beam; and
a third controller that issues an alarm or stops the emission of the modulated laser beam when the modulated laser beam is detected by the laser beam detector.

11. The communication system according to claim 1, wherein the laser beam is an invisible laser beam with a wavelength outside the visible region.

12. The communication system according to claim 1, wherein the invisible laser beam is a laser beam with a wavelength in the infrared region.

13. The communication system according to claim 1, wherein the first device or the second device is an image pickup apparatus, a portable information apparatus, a portable radiographic image converter, or an image reader that reads image information from a portable radiographic image converter.

14. A communication system comprising:
a first device comprising,
a first housing that comprises a first guiding member,
a modulator that modulates a laser beam in accordance with transmission information, and
an emission unit that emits the laser beam that has been modulated at the modulator; and
a second device comprising,
a second housing that comprises a light-receiving region on an outer surface of the second housing,
a receiver that, when a relative position between the first and the second housings is adjusted to a communicable position at which the modulated laser beam is incident within the light-receiving region, receives the transmission information from the first device by detecting the modulated laser beam and demodulating the transmission information based on the detection result; and
a holder that is disposed on the second housing and prevents relative displacement between the first housing and the second housing by holding the first housing when the relative position between the first and the second housings is adjusted to the communicable position.

15. The communication system according to claim 14, wherein
the first device comprises a first engaging portion that is disposed on a surface of the first housing that is opposed to the second housing, and
the holder is disposed on a surface of the second housing that is opposed to the first housing at a position which corresponds to the first engaging portion, and is a second engaging portion that engages with the first engaging portion.

16. The communication system according to claim 14, wherein
the first device comprises an attracting portion that is disposed on a surface of the first housing that is opposed to the second housing, and
the holder is disposed on a surface of the second housing that is opposed to the first housing at a position which corresponds to the attracting portion, and is an electrical magnet that is configured to attract the attracting portion.

17. The communication system according to claim 14, wherein
the first device comprises a first connector comprising a plurality of first terminals disposed on a surface of the first housing that is opposed to the second housing, and
the holder comprises a plurality of second terminals disposed on a surface of the second housing that is opposed to the first housing at positions corresponding to the plurality of first terminals, and the holder is a second connector that electrically connects the plurality of first terminals and the plurality of second terminals by engaging with the first connector.

18. The communication system according to claim 17, wherein the emission unit operates using power supplied through the first and the second connectors.
